(19) United States
(12) Patent Application Publication
(10) Pub. No.: US 2016/0184164 A1
(43) Pub. Date: Jun. 30, 2016

(54) Physical Therapy and Patient Movement System

(71) Applicant: Johnny C. Browning, Alapaha, GA (US)

(72) Inventor: Johnny C. Browning, Alapaha, GA (US)

(21) Appl. No.: 14/952,905

(22) Filed: Nov. 25, 2015

Related U.S. Application Data
(60) Provisional application No. 62/083,898, filed on Nov. 25, 2014.

(51) Int. Cl. A61H 3/00; A63B 21/015

(52) U.S. Cl. CPC A61H 3/00; A63B 21/015

(57) ABSTRACT

A physical therapy and physical assist apparatus and system includes a vertical support pole with mount for ceiling and floor. A shaft in combination with the pole is used to adjust the height of the pole to fit the distance between ceiling and floor and mount the apparatus. At least one handle is attached to the vertical pole and via a rotating head and brake assembly. The brake assembly includes a brake pad for adjustment of resistance on a walk-around arrangement thereof. The handle includes a 25 degree kick out in the walk-around arrangement of the apparatus.

### PRIORITY CLAIM

The present application claims benefit of United States provisional patent application No. 62/083,898 filed by applicant, Johnny C. Browning, on Nov. 25, 2014.

### FIELD OF THE INVENTION

The present invention relates to physical therapy and patient movement systems, and more particularly pertains to a medical walk-around device for enabling patients and immobile individuals to perform physical therapy at home.

### BACKGROUND OF THE INVENTION

Individuals recovering from a stroke, a broken hip or limb or other debilitating disease or condition require physical assistance and physical therapy to regain mobility and maintain strength. Without movement, atrophy of muscles and calcification of joints can set in and cause further pain, discomfort and long-term limitations on mobility. Those who are immobile face challenges in the simple tasks rising and moving between two points. The present invention helps to overcome these problems by providing a system that enables both basic movement between two points and physical therapy for improving overall mobility.

### SUMMARY OF THE INVENTION

A first embodiment provides a floor to ceiling vertical support pole with handles attached to a rotating head. The rotating head includes a brake for resistance. The pole is adjusted to fit between floor and ceiling mounts using a screw jack. The screw jack is covered by a tubular square sleeve. The rotating head and brake housing include an ultra-high-molecular-weight polyethylene, referred to herein as UHMW, bearing in cooperation with a collar for rotation. An UHMW pad slides down and rests on the square to round bushing of the collar. The brakes is contained so that as the knobs turn, a shaft presses against brake pad and gives the adjustable amount of resistance desired. The UHMX bushings abutting next to each other provide quiet and smooth operation while the head rotates. A set screw retains the handle and eliminates any minute movement. The handle extends horizontally and includes a double rail handle with a 25 degree kick out. The kick out gives a perception to a person using the apparatus that they are walking straight rather than in circles around the pole.

In a second embodiment a system for getting out of a bed is provided for elderly or immobile person who cannot stand from supine position in a bed. The system of grab rails includes multiple positions of rails for movement from supine to standing position, and then to a utilitarian position to use a portable toilet or other utility. The system is stationary once set up and adjusted to the person using. The handles of the two different handle sections of the system are fastened by multiple set screws by finding the comfortable height depending on the bed and the user. The double handle section of the system can rotate so that the double handles are set to a specific distance, preferably from 25″ to 36″ from a bed. A pillow side grab bar of the system provides a first grab handle for the user and then a second handle on the double handle section is used to pull the body upward. This embodiment enables greater mobility and can allow an immobile person to be able to function in a less restrictive environment such as a home and can reduce the amount of assistance and labor needed from caretakers.

In a third embodiment for tub or shower with threshold, a portion of the handle mounts on the outside of the shower, and a portion of the handle protrudes into shower area. The handle is fixed in a particular horizontal position and height to assist a person entering the tub or shower. This embodiment using same bar for the handle as the walk-around rotating embodiment, but with the handle being fixed as a permanent bar to assist with the utility of entering a tub or shower. The bar includes the 25 degree kick out section of the bar.

An objective of the present invention is to provide a system for therapy or physical assistance that can be used inside of a home or any building where typical ceiling joists and rafters are used for framing.

Another objective is to provide an apparatus used by people with physical disabilities that require something to hold on to during walking therapy.

Another objective to provide an apparatus that can be installed or disassembled in very quickly.

### BRIEF DESCRIPTION OF THE DRAWINGS

The invention is better understood and objects other than those set forth will become apparent when consideration is given to the following detailed description. Such description makes reference to the figures listed as follows:

FIG. 1 is an exploded perspective view of a physical therapy and patient movement system in accordance with a preferred embodiment of the present invention.

FIG. 2 is a perspective view of a preferred installation feature of the preferred embodiment of the physical therapy and patient movement system of the present invention.

FIG. 3 is an exploded perspective view of section 3 of FIG. 1 of the physical therapy and patient movement system in accordance with the particular preferred embodiment of the present invention.

FIG. 4 is an exploded perspective view of section 4 of FIG. 1 of the physical therapy and patient movement system in accordance with the particular preferred embodiment of the present invention.

FIG. 5 is a perspective view of a physical therapy and patient movement system in accordance with a preferred embodiment of the present invention.

FIG. 6 is a sectional perspective view of handles of the physical therapy and patient movement system in accordance with a preferred embodiment of the present invention.

FIG. 7 is a top elevation sectional view of a first device with two handles of the physical therapy and patient movement system in accordance with a preferred embodiment of the present invention.

FIG. 8 is a top elevation sectional view of a second device with a single handle of the physical therapy and patient movement system in accordance with a preferred embodiment of the present invention.

FIG. 9 is an exploded perspective view of a first device with two handles of the physical therapy and patient movement system in accordance with a preferred embodiment of the present invention.

FIG. 10 is a front elevation view of a suspended handle of a third device of the physical therapy and patient movement system in accordance with a preferred embodiment of the present invention.

FIG. 11 is a front elevation view of a suspended handle of a third device with a first single handle and a second suspended handle of the physical therapy and patient movement system in accordance with a preferred embodiment of the present invention.

### DETAILED DESCRIPTION

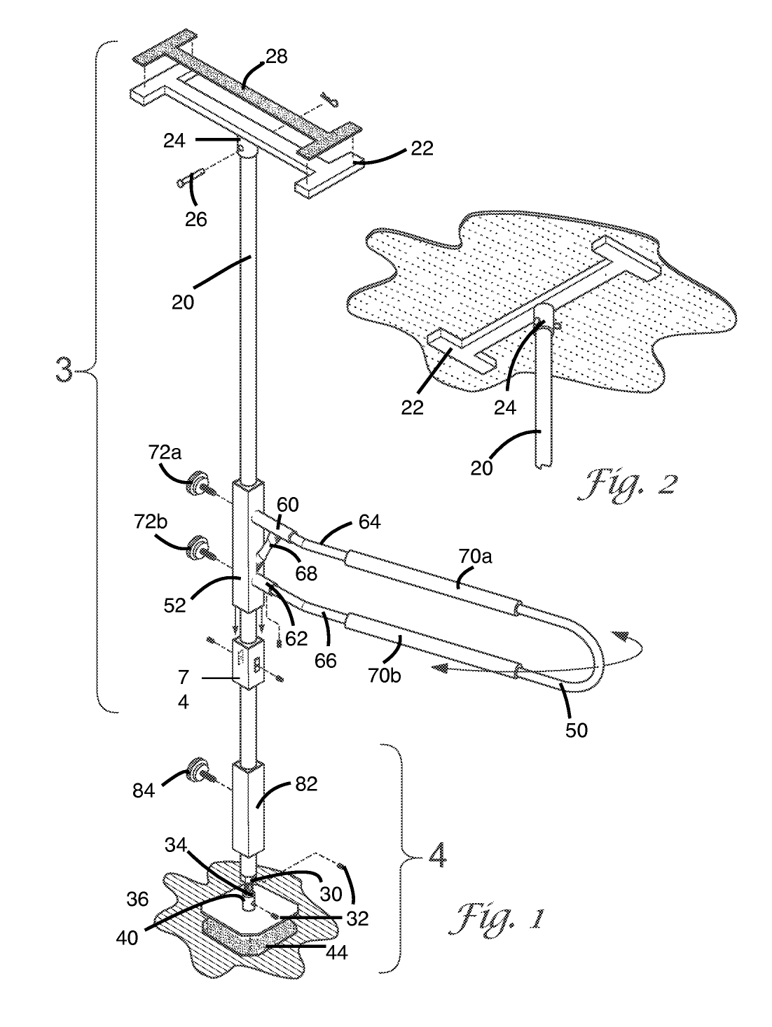

Referring now to the drawings, several exemplary embodiments of the invention are described. The figures labeled 1-4 illustrate a preferred embodiment of a physical therapy and patient movement system. The embodiment provides a self-assist walk-around assembly, and the installation and assembly details are shown in the figures. The self-assist walk-around assembly shown in FIG. 1 provides a physical assist apparatus for physical therapy and walking. The embodiment mounts an elongate vertical pole 20 between a floor and a ceiling, with a first end attached to the ceiling via a mount and a second end attached to the floor via a shaft and mount. The assembly mounts to the ceiling via an upper mount that is attached to the top of the pole. The upper mount comprises a horizontal ceiling plate 22 that uses pressure to secure the plate 22 to the ceiling. The ceiling plate has a short receiver tube 24 with predrilled hole, allowing attachment of vertical pole 20 using a fastener such as clevis pin 26. The ceiling plate 22 may include predrilled holes 16″ and 24″ apart allowing attachment to both 16″ and 24″ standard ceiling joist spacing using wood screws. The ceiling plate 22 also includes a padding for placement between the ceiling plate and ceiling that may comprise three 2″ wide by ⅛″ thick by 7″ long rubber strips 28 located on a contact side of the ceiling plate. The rubber strips 28 prevent scratches and scuffing of ceiling surfaces. In addition, the rubber strips 28 prevent the ceiling plate 22 from slipping and or sliding on ceiling surface. If the ceiling plate includes open tubing, rubber plugs may be inserted into open ends of the ceiling plate tubing for cosmetic appearance.

The floor to ceiling vertical support pole 20 is attached to a shaft assembly. The support pole 20 is inserted into the receiver tube 24 located on ceiling plate 22 and secured with clevis pin 26, while the shaft assembly is supported on the floor. In the embodiment of FIG. 1, a threaded receiver 30 is pre-welded onto an opposite end of the support and pole 20 and shaft assembly combination. Set screws 32 are located on sides of the threaded receiver 30, preventing the support pole 20 from rotating when a handle 50 of the self-assist assembly is in use.

The shaft assembly connected to the support pole 20 includes a 1″ diameter by 12″ long threaded shaft 34 that is screwed into the threaded receiver 30 coupled to the lower end of the support pole 20 by a first end of the shaft. The second end of the threaded shaft 34 is inserted into the threaded receiver 30 that is attached to a stanchion floor plate 36. The threaded shaft is not completely round in the embodiment shown; the two sides opposite one another have been machined flat allowing the set screws 32 to tighten against the flat surfaces. The threaded shaft 34 has a ⅜″ diameter hole 38 drilled through the shaft 34 from one flat side to the opposing flat side. The hole 38 allows a straight tool 39 such as a screw driver to be inserted into the hole 38. The tool may be used to turn the shaft 38, thus adjusting tension or compression from floor to ceiling of the support pole 20 via the shaft 38. In the preferred embodiment, the 12″ long threaded shaft 38 allows adjustment of the system for various ceiling heights from 92″ to 102″.

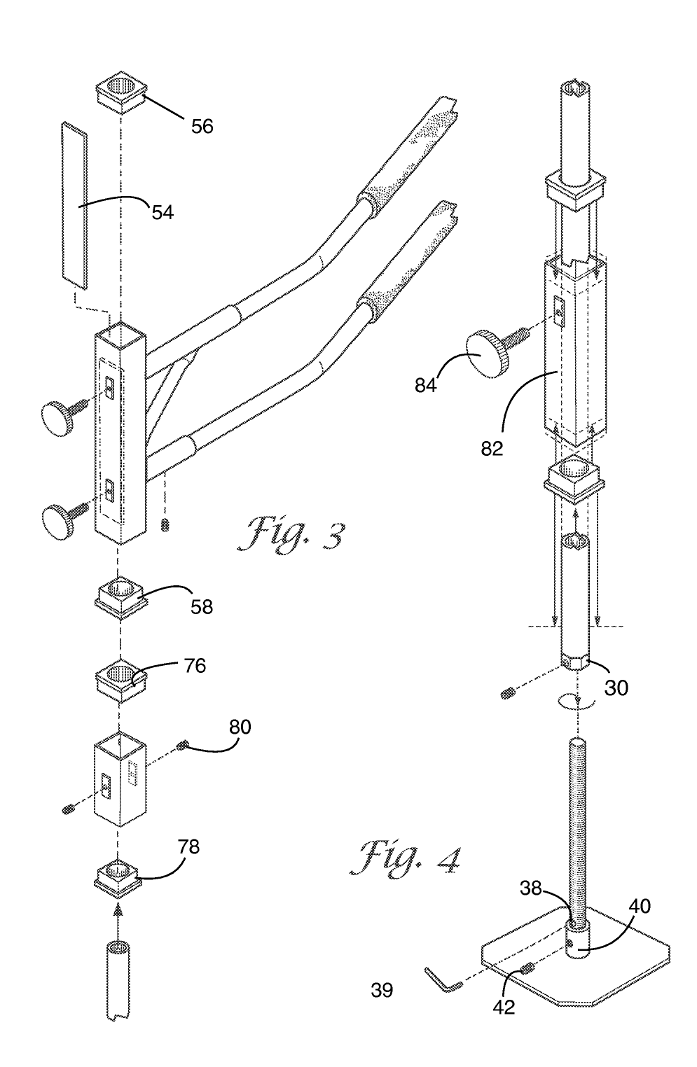

As shown in FIG. 4, the floor plate 36 has a welded stanchion in center of the 8″ by 8″ square floor plate 36. Corners of the floor plate 36 may be cut off to allowing a smooth and clean appearance. Further, two predrilled holes in the floor plate may be disposed therein to allow attachment of the floor plate 36 to the floor to secure the assembly. However, tension and compression of the shaft 38 and pole 20 combination may allow the assembly to be installed without permanent attachment. A set screw 42 is located on side of stanchion 40. Two 2″ wide by ⅛″ thick by 7″ long rubber strips or rubber padding 44 may be glued to bottom side of floor plate 36. The rubber strips protect the floor and prevent slipping of the assembly.

The assembly includes a rotating head that comprises an oversized square tube or square tube head 52 that is situated on the pole 20 and shaft 34 around the round tubular support pole formed by the combination of the pole and shaft. This square tube head 52 forms the main body of the rotating head and includes a brake, also referred to as a brake pad 54. The square tube head 52 is 0.590″ larger (oversized) than the round tube of the pole and shaft, allowing the insertion of a 2″ wide by ⅛″ thick UHMW anti-friction pad, comprising the brake pad 54, inside the square tube's interior wall. UHMW square-to-round bushings 56 and 58 located at both ends of the square tube head 52 retain the brake pad 54 inside. The square portion of the bushings 56 and 58 are machined to fit tight and firm within the square tube head 52. The round hole of the bushings 56 and 58 is machined to allow the device to rotate smoothly and easily when inserted through the bushings.

The assembly has two horizontal receiving tubes 60 and 62 attached perpendicular and horizontally situated to the square tube head 52. A bent handle 50 is inserted into the receiving tubes 60 and 62. The upper tube portion 64 of the handle 50 may include a drilled hole and retaining button located near the end. The upper receiving tube 60 may include drilled receiving hole to allow the retaining button to fit into the receiving hole of the tube 60. The lower (shorter) receiving tube 62 may include a set screw to prevent the lower tube portion 66 of the handle from moving and to fix the handle to the receiving tubes. A gusset brace 68 from the bottom of upper tube portion 64 to the square tube head 52 allows longer handles up to 48″ to be installed securely on the assembly. A preferred standard length for the handle is 40 inches. The bent handle 50 includes a 25-degree bend along the horizontal length of the handle, allowing a more comfortable and ergonomic feel for the user. The upper handle tube portion 64 may include a foam grip 70a of about 15″ in length attached to the upper tube portion 64. The lower handle tube portion 66 may also include a foam grip 70b. The handle 50 shown in FIG. 1 and FIG. 3 may be referred to as a 180 degree handle because of it's half oval shape. A 180 degree handle as shown has greater strength, stability, and is safer than single handles of the same length.

The square rotating head assembly has two brake adjusting devices comprising the brake knobs 72a and 72b. Turning each knob causes a compression mechanism to move inward to tighten the brake pad against the pole. In the embodiment, as each knob tightens a bolt, the shank of each bolt pushes against the UHMW brake pad 54, and the brake pad 54 pushes against the round pole 20, thus creating resistance. The user can now set the desired resistance for walking around the pole and exercising.

The rotating head assembly is adjustable to set a desired height by positioning a square lock collar 74 to desired height. In the embodiment of FIG. 1 and FIG. 3, the lock collar is shown comprising the square collar 74 with square-to-round UHMW bushings 76 and 78. The lock collar 74 is secured to the pole 20 with two set screws 80. The square rotating head assembly sits on top of lock collar controlling the vertical position of the rotating head assembly. The lower UHMW bushing 58 of the rotating head assembly rotates on the top of upper UHMW bushing 76 of the lock collar assembly thus resulting in a quiet, smooth vibration-free rotation.

A cover 82 is provided comprising square tubing with square-to-round UHMW bushing in an upper end of the cover. A bottom end of the cover 82 may be left open without a bushing, allowing the cover to be lowered over the threaded shaft 34 of the threaded shaft assembly without obstruction. Means is provided for attaching the cover 82 including a knob 84 with a threaded shank that is located on an upper end of the cover 82 allowing a user to raise the cover and turn the knob to hold the cover in position while making adjustments. One may loosen the knob 84 and lower the cover 82 to a “down” position and then tighten the knob, thus preventing vibration and rattle while the device is in use. In addition, the cover 82 covers up mechanical parts of product.

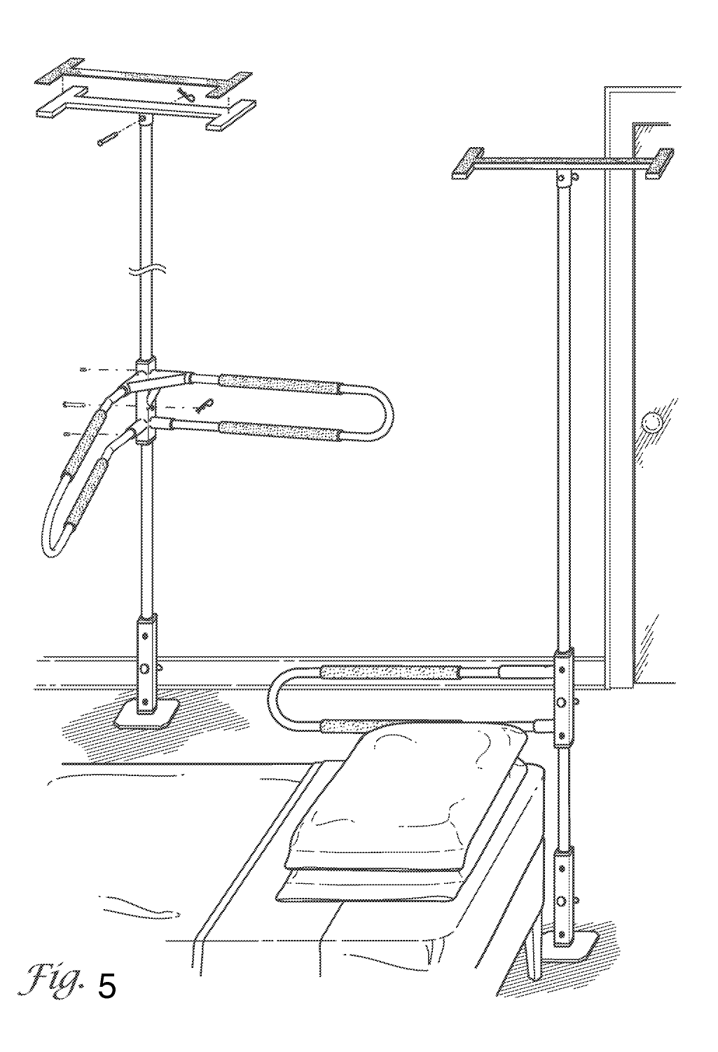

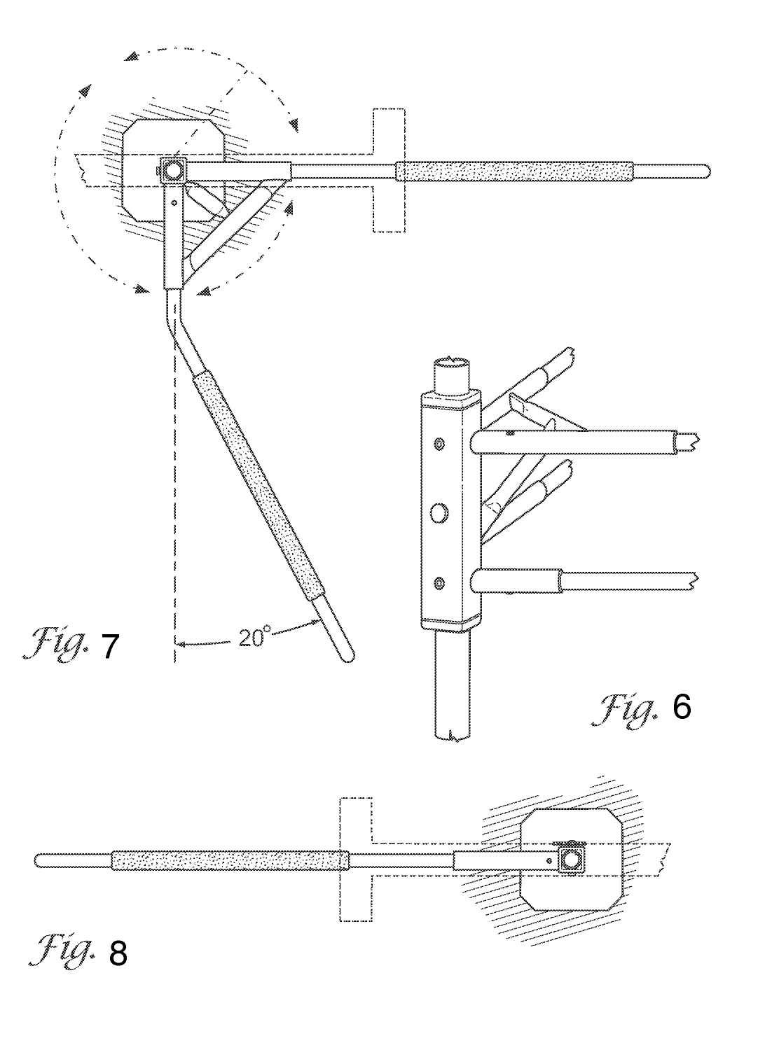

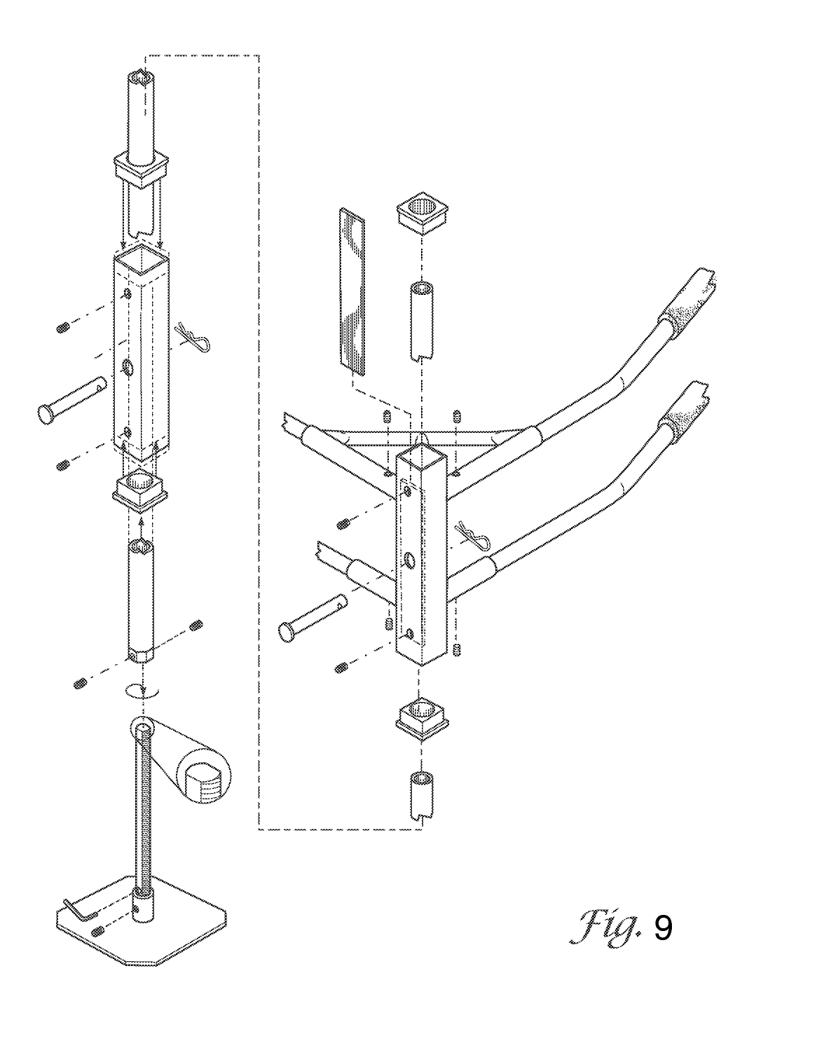

Referring now to FIGS. 5-11, a second embodiment of the apparatus for assisting a physically handicapped person in movement from a supine position in a bed to a utilitarian position is shown. Referring to FIG. 1, like the walk-about device in the first embodiment, this embodiment also includes a ceiling mount 102 for attachment of each vertical pole 100. The device mounts to a ceiling by means of the ceiling plate 102. Ceiling plate 102 has a short receiver tube 104 with a predrilled hole, allowing attachment of the vertical pole 100 using a clevis pin 106. Each ceiling plate 102 may include predrilled holes 16″ and 24″ apart allowing attachment to both 16″ and 24″ standard spaced ceiling joists using wood screws. The ceiling plate 102 may also include padding 108, such as three 2″ wide by ⅛″ thick by 7″ long rubber strips located on a contact side of the ceiling plate. The padding prevents scratches and scuffing to ceiling surfaces. In addition, the padding prevents the ceiling plate 102 from slipping and or sliding on ceiling surface. Rubber plugs may be inserted into open ends of ceiling plate tubing for cosmetic appearance.

As in the first embodiment, the vertical pole 100 extends from floor to ceiling with a shaft 114 to provide tension and compression in mounting the device between the floor and ceiling. At the ceiling, the pole 100 is inserted into receiver tube 104 located on the ceiling plate 102 and secured with clevis pin 106. Meanwhile, a threaded receiver 110 is pre-welded onto a floor plate 116 and receives an opposite end of the vertical support pole 100 (floor end) via a shaft 114. Two set screws 112 are located on a side of the threaded receiver to prevent the support pole 100 from rotating when a handle 120 or 130 is in use.

The first device in the second embodiment has two opposing receiver tubes 122a, 122b connected (welded) horizontally and perpendicular to the square tube main head 124. The square tube main head 124 has two (one on each end) square-to-round reducing bushings 126 and 128 (UHMW) allowing the square head 124 to fit onto the round floor to ceiling pole 100. The square head 124 is now positioned at a desired height and secured by tightening the four cone tip set screws 130. The square head 124 has a grab bar 132 connecting the two opposing upper receiver tubes 122a and 122b, thus creating a continuous grab bar 132 horizontal and perpendicular to the pole 100. A gusset brace 134 connects to the bottom of the grab bar 132 and connects to the square head 124. The upper receiver tubes 122a are longer than lower receiver tubes 122b allowing much easier insertion of the 180 degree hand rails, such as grab bar 132.

In a second device of the second embodiment, angularly opposed hand rails 140a and 140b that are separated by about 90 degrees of offset along a horizontal plane comprise 180-degree semi-oval shaped handles. The tubing of the hand rails 140a and 140b and are approximately 33″ in overall length with an eight inch C.L.R. (center line radius) between the rails. Upper receiver tubes have a drilled hole 2″ from the end, and the upper 180-degree handle has a drilled hole with retaining button used to secure the handle rail inside the receiver tube. A lower receiver tube has a set screw used to secure lower the 180-degree handle. The 180-degree hand rail pointing toward the bed (when installed) has a 25-degree horizontal bend allowing the end of the hand rail to be easier to reach from bed. This device has several improvements and advantages over a single direction grab bar. First, the 90 degree (“L shape”) two directional hand rails allows a disabled person to make a 90 degree turn, while holding the hand rails to better position themselves to sit in wheel chair or potty. Second, a disabled person can support themselves much better with two opposing hand rails (one in left hand, other in right hand). Third, the 180 degree bent hand rails allow a disabled person to grab the higher rail or lower rail depending on the person's position and or physical ability.

A floor plate for receiving the lower end of the vertical poles has a welded stanchion in the center of the 8″ by 8″ square floor plate. Corners of the floor plate have been cut off, allowing a smooth and clean appearance. Two predrilled holes allow attachment of the floor plate to the floor. A set screw is located on a side of the stanchion. For padding, two 2″ wide by ⅛″ thick by 7″ long rubber strips are glued to bottom side of floor plate. Rubber strips protect floor and prevent slipping.

The self-assist walk-around includes the shaft 34 that forms a screw jack for adjustment of the height of the pole. Meanwhile, the square tube 52 of the head assembly or rotating head assembly includes improved rotational properties because of the combination of the lock collar 74 with bushing 76 and the head assembly comprising the square tube 52 and bushing 58. The UHMW bushing pad 58 of the head assembly slides down the pole 20 and rests on a round bushing portion of the square-to-round bushing 76. The brake system with pad 54 is contained within the head assembly so that when the adjustment knob 72a and 72b turns, a threaded shank presses against brake pad 54, which then rubs against the vertical pole 20 and creates resistance for the head assembly that rotates with the handle 50 as a person walks around the pole. A set screw retains the double rail handle 50 in combination with a button that fits into its position in the assembly of the rails. The set screw eliminates minute movement and provides a firm fit for the handle 50. The handle 50 provides a 25 degree kick out for aesthetics and gives the perception that one is walking straight rather than walking around the pole 20. By loosening the set screw, the handle can be taken out and flipped over and slid back in. In doing so, one must take button out and put back in. The part is interchangeable either way.

The combination of the pillow side grab bar apparatus in the second embodiment discussed above and the self-assist walk-around apparatus of the first embodiment discussed provides a system for physical therapy. While the walk-around apparatus is mobile for physical therapy, the pillow side grab bar apparatus is stationary after adjusted using the set screws provided for the handles to move both vertically and rotationally about the pole. In the recommended positions the pillow side grab bar distance is important and can be positioned as a matter of positioning on the vertical pole. The pillow side grab bar apparatus quickly allows a person to move by themselves, and the ability to move is therapeutic. The system of the pillow side grab bar apparatus and the self-assist walk-around apparatus together promotes both getting out of bed and rehabilitative physical movement.

The self-assist walk-around apparatus may be modified in an additional embodiment by providing a handle in a fixed position without the rotating head and brake system. In this embodiment, the device may be used to assist a person in standing or for entering a shower or tub area. For instance, for a shower or tub entry, the vertical pole may be mounted on the outside of a shower, and the handle section of the apparatus may be situated to protrude inside. This arrangement is useful with hand wand washing and sitting in a chair within a shower. This embodiment may use the same bar as the walk-around rotating version, except it will only have two and it is locked down, fastened permanently into the desired position.

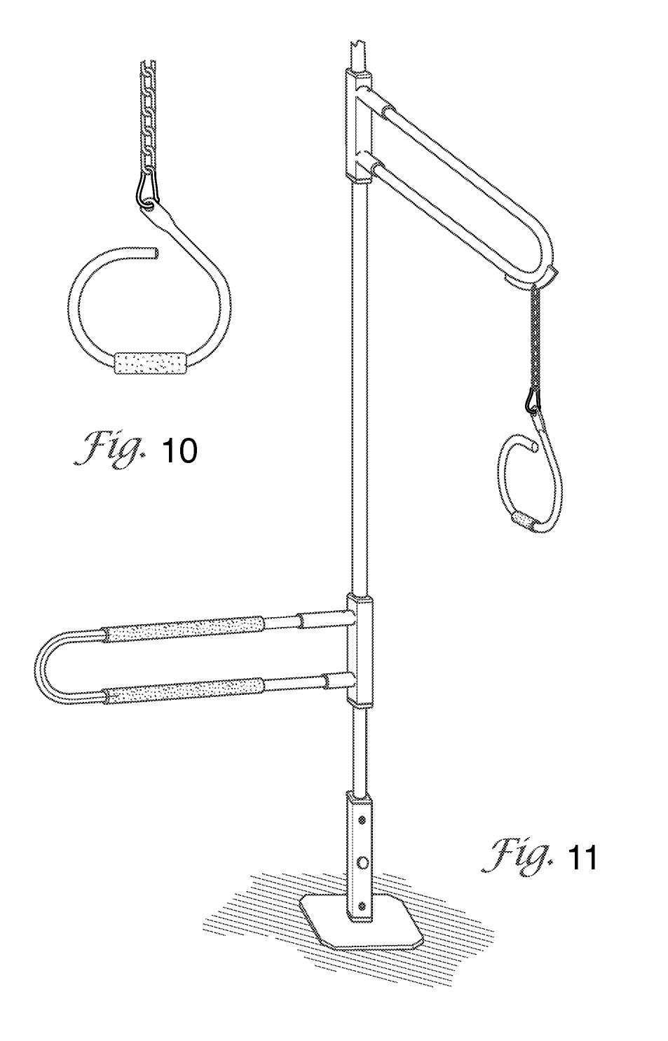

FIG. 10 and FIG. 11 illustrate another embodiment of the invention having a suspended handle. A continuous grab bar is situated horizontal and perpendicular to the pole 100 as in the device of FIG. 5. However, a second bar is provided on the pole situated at an angle to the first bar and above. An additional suspended handle is attached to the second bar. The suspended handled may be attached by a chain to the second bar as shown in FIG. 11. Further, the handle may be shaped as a ring for easy grabbing by a person. The suspension cable or chain in combination with the ring allows a person to reach up to grab the ring and them pull themselves upwards with one hand, while at the same time pulling or pushing themselves upwards using the lower continuous grab bar.

I claim:

1. A physical therapy system having an apparatus comprising:
a. a support pole;
b. a ceiling plate attached to a ceiling and receiving a first end of the support pole;
c. a shaft receiving a second end of the support pole;
d. said shaft attached to a floor plate for attachment to a floor;
e. a brake assembly rotationally attached to the support pole;
f. said brake assembly comprising a pad within the brake for frictional engagement of the pole to create resistance to rotation of the brake assembly about the pole;
g. a brake adjustment device attached to the brake assembly for adjustment of the pad to adjust resistance between the brake pad and the pole; and
h. a handle attached to the brake assembly for engagement by a person for rotation of the brake assembly about the pole while walking.
